(19) United States
(12) Patent Application Publication
(10) Pub. No.: US 2002/0027412 A1
(43) Pub. Date: Mar. 7, 2002

(54) Fluoride-based fluorescent material and fluorescent lamp using same

(75) Inventors: Hisashi Yoshida, Shiga (JP); Maki Minamoto, Shiga (JP); Masato Hayashi, Shiga (JP); Shiro Sakuragi, Ibaraki (JP); Takeshi Hirai, Ibaraki (JP)

Correspondence Address: SUGHRUE, MION, ZINN,, MACPEAK & SEAS, PLLC, 2100 Pennsylvania Avenue, N.W., Washington, DC, 20037-3213, US

(73) Assignee: NEC CORPORATION

(21) Appl. No.: 09/901,664

(22) Filed: Jul. 11, 2001

(30) Foreign Application Priority Data
Jul. 13, 2000 (JP) 2000-212735

(51) Int. Cl. H01J 61/44; H01J 61/16

(52) U.S. Cl. 313/486; 313/576

(57) ABSTRACT

A fluoride-based fluorescent material designated by a composition formula of MFₙ:R, wherein M is at least one element selected from the group consisting of rare earth elements, Al and Bi, alkaline earth metals, and alkaline metals, and R is a rare-earth-based activator including at least either Tb or Tb and Ce and n=1, 2 or 3. The fluoride-based fluorescent materials efficiently emit white-light of a luminescent peak at 543 nm.

### BACKGROUND OF THE INVENTION

1. Field of the Invention

The present invention relates to a fluoride-based fluorescent material and a fluorescent lamp using the same.

2. Description of the Related Art

Fluorescent materials are excited by the 254 nm Hg-resonance line and consequently emit visible light. Examples of the fluorescent material include green-light emitting LaPO₄:Tb³⁺, Ce³⁺ and CeMgAl₁₁O₁₉:Tb³⁺, red-light emitting Y₂O₃:Eu³⁺, and blue-light emitting BaMg₂Al₁₆O₂₇:Eu²⁺. White-light emitting fluorescent lamps using a fluorescent layer made of such fluorescent materials that emit light with a narrow-band of three primary colors, are also commercially available. Fluorescent lamps of this type, called 3-wavelength fluorescent lamps, are noted for their high efficiency and high color rendering capability. Such fluorescent lamps are used in applications ranging from normal lighting to the back light in liquid crystal displays (LCD) and light sources for scanning original documents of OA equipment such as facsimiles, image scanners and copiers. The green-light emitting fluorescent materials are particularly suitable for use in the light sources of copiers.

A fluorescent lamp of this type includes a structure of which the major part is shown in FIG. 1A exemplifying a straight tube type cold-cathode fluorescent lamp suitable for use in the back light of LCDs. Inside a transparent glass tube 51 having a diameter of several millimeters, a fluorescent layer 52 is formed that is several tens of micrometers thick and emits visible light when excited by ultraviolet light. A rare gas such as argon (Ar) and several milligrams of Hg are sealed in the glass tube 51. Leads 53 and 54 are sealed in both ends of the glass tube 51, and the ends of the leads 53 and 54 have cold cathode sleeves 55 and 56, made of Ni. The cold cathodes 55 and 56 are filled with Hg—Ti alloy as a Hg source, and Zr—Al alloy powder as a getter.

An example of a hot-cathode fluorescent lamp suitable for use in normal lighting and copiers is shown in FIG. 1B. Inside the glass tube 51 having a diameter of several tens of millimeters, a fluorescent layer 52 is formed that is several tens of micrometers thick and emits visible light when excited by ultraviolet light. A rare gas such as argon and several milligrams of Hg are sealed in the glass tube 51. Leads 58 and 59 are sealed in both ends of the glass tube 51, and the ends of the leads 58 and 59 each have a hot-cathode 60 made of a tungsten filament where electron emitting materials are formed.

Also, there are, for example, fluorescent materials that emit visible light when excited by vacuum ultraviolet light of 147 nm and 172 nm which are produced by discharge from Xe contained in Xe-based rare gases. Such fluorescent materials include green-light emitting BaA₁₂O₁₉:Mn²⁺ and Zn₂SiO₄:Mn, red-light emitting (Y, Gd)BO₃:Eu³⁺ and Y₂O₃:Eu³⁺, and blue-light emitting BaMgAl₁₀O₁₇:Eu²⁺ and BaMgAl₁₄O₂₃:Eu²⁺. These fluorescent materials emitting light of three primary colors are suitable for use in the fluorescent layers in plasma display panels (PDP). When these fluorescent materials are used in the fluorescent layers of rare gas discharge lamps, fluorescent lamps using no Hg can be provided that are white-light type lamps suitable for use in the backlight of LCD and OA equipment.

However, the above-mentioned white-light fluorescent lamps using Hg are expensive because they require three expensive fluorescent materials. In addition, since the emitted fluorescence changes in intensity with time depending on the property of each fluorescent material, aging causes the color of output light to change with respect to its original color. Further, the use of Hg causes environmental pollution. Although Hg is not used in the rare gas fluorescent lamps excited by vacuum ultraviolet light radiated from Xe, the intensity of their output light is not high enough and they are expensive because they need three expensive fluorescent materials. Further, if the fluorescent materials for the fluorescent lamps using Hg are employed in rare gas fluorescent lamps, the intensity of output light is reduced. For example, when the green-light emitting fluorescent materials such as LaPO₄:Tb³⁺, Ce³⁺ and CeMgAl₁₁O₁₉:Tb³⁺ are excited by vacuum ultraviolet light of 172 nm and 147 nm, the intensity of output light becomes lower than that attained by excitation with the 254 nm Hg-resonance line.

### SUMMARY OF THE INVENTION

In view of the foregoing, a first object of the present invention is to provide a new fluorescent material that efficiently emits white-light when excited by vacuum ultraviolet light (ultraviolet light having a wavelength of 200 nm or shorter, such as 172 nm and 147 nm light emitted from Xe and 185 nm light emitted from Hg).

A second object of the present invention is to provide an inexpensive, bright fluorescent lamp that includes a fluorescent layer made of the above-mentioned fluorescent material.

Thus, the present invention provides, in a first aspect thereof, a fluoride-based fluorescent material designated by a composition formula of MFₙ:R, wherein M is at least one element selected from the group consisting of rare earth elements, Al and Bi, alkaline earth metals, and alkaline metals, and R is a rare earth-based activator including at least either Tb or Tb and Ce and n=1, 2 or 3.

In accordance with the first aspect of the present invention, the fluorescent materials efficiently emit white-light of a luminescent peak at 543 nm among other peaks in the green, blue and red bands when excited by ultraviolet light such as vacuum ultraviolet light (ultraviolet light of a wavelength of 200 nm or shorter) and Hg-resonance line (wavelength of 185 nm).

The present invention provides, in a second aspect thereof, a fluorescent lamp including a transparent hermetic vessel, a fluorescent layer including the fluorescent material as defined in the first aspect inside the transparent hermetic vessel, a discharge medium sealed in the hermetic vessel in association with the fluorescent layer, and a pair of electrodes for discharging the discharge medium.

In accordance with the second aspect of the present invention, the fluorescent lamp efficiently emits white-light so that it is suitable for use in the backlight of an LCD and the scanning light source of a facsimile, image scanner and copier.

The above and other objects, features and advantages of the present invention will be more apparent from the following description.

### BRIEF DESCRIPTION OF THE DRAWINGS

FIGS. 1A and 1B are sectional views of the major part of the conventional straight tube type fluorescent lamps.

FIG. 2 is the luminescent spectrum of the fluoride-based fluorescent material YF₃:Tb.

FIG. 3 is the luminescent spectrum of the fluoride-based fluorescent material GdF₃:Tb.

FIG. 4 is the luminescent spectrum of the fluoride-based fluorescent material Y_{0.5}Gd_{0.5}F₃:Tb.

FIG. 5 is the luminescent spectrum of the conventional fluorescent material LaPO₄:Tb,Ce.

FIG. 6 is a cross-sectional view of the major part of a straight tube type cold cathode fluorescent lamp in accordance with an embodiment of the invention.

FIG. 7 is a perspective view of a flat type fluorescent lamp in accordance with another embodiment.

FIGS. 8A and 8B are sectional views of the main structure and electrode geometry of another flat type fluorescent lamp.

FIGS. 9A and 9B are a side view and a sectional view taken along A-A line, respectively, of a fluorescent lamp having no inner electrodes.

FIG. 10 is a cross-sectional view of the major part of a straight tube type cold cathode fluorescent lamp having color filters.

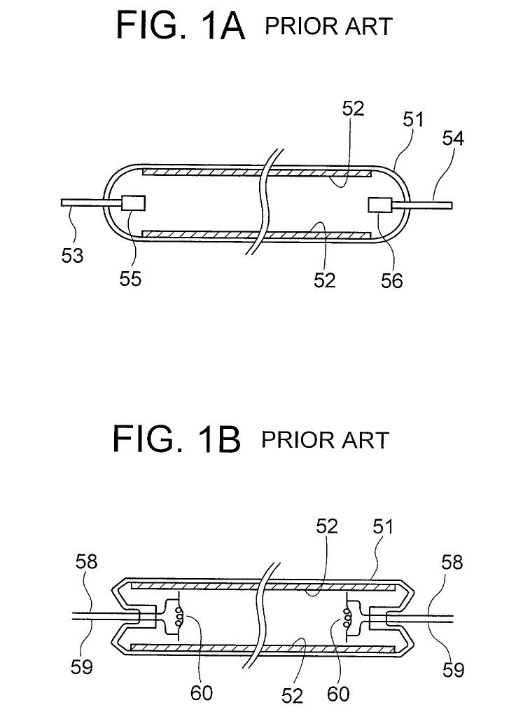

### PREFERRED EMBODIMENTS OF THE INVENTION

Examples of the fluoride-based fluorescent material designated by the composition formula of MFₙ:R include M(III)F₃:R, M(II)F₂:R and M(I)F:R.

Accordingly, in a first embodiment of the present invention, the fluoride-based fluorescent material is the material that is activated by rare-earth material and has a composition of M(III)F₃:R (M(III) is at least one element selected from rare-earth elements, Al (aluminum) and Bi (bismuth), and R is a rare-earth-based activator including at least either Tb, or Tb and Ce). M(III) is at least one element selected from Y, Sc, La, Ce, Pr, Nd, Pm, Sm, Eu, Gd, Tb, Dy, Ho, Er, Tm, Yb, Lu, Al and Bi, preferably Y, La and Gd. Tb is preferred as an activator and if both Tb and Ce are used as a double activator, the intensity of output light increases because of the sensitizing effect of Ce. Other rare-earth elements may be added to Tb or the combination of Tb and Ce.

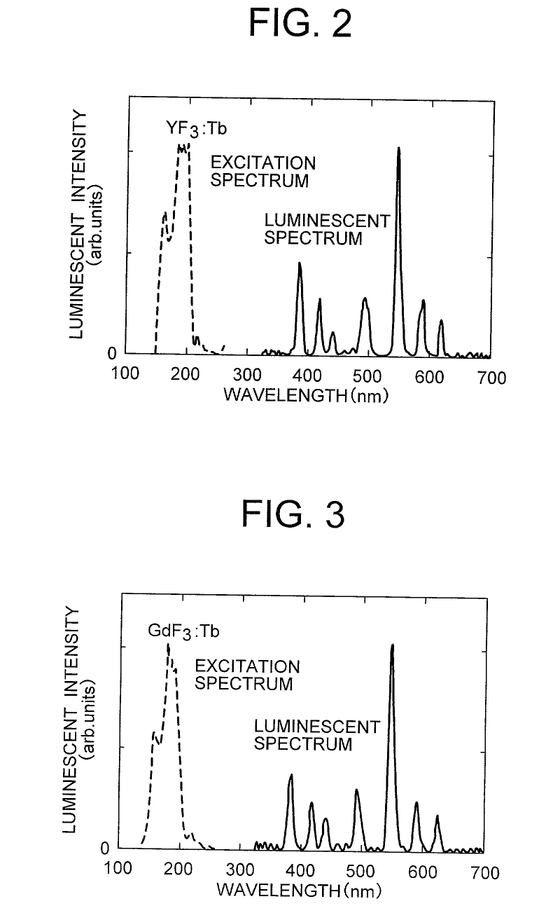

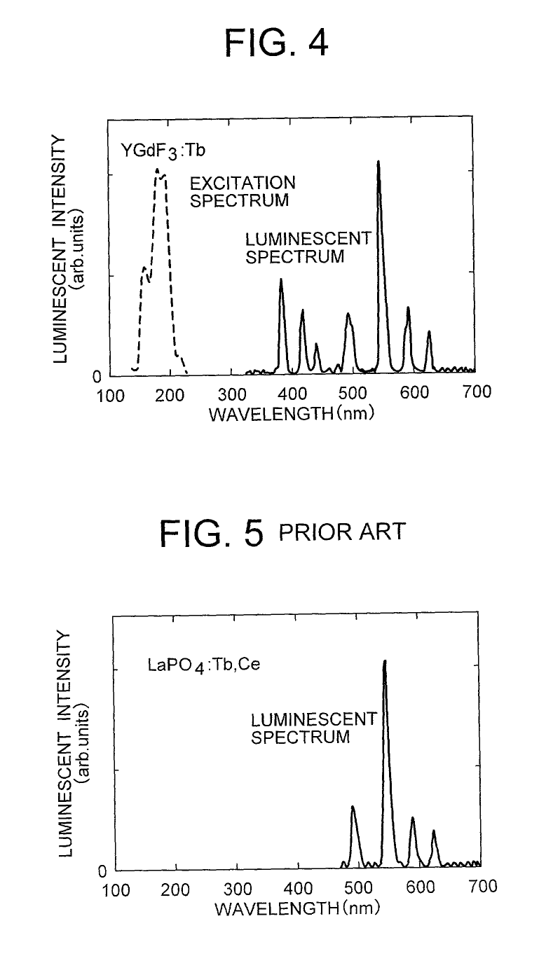

Specific fluorescent materials are, for example, YF₃:Tb, GdF₃:Tb, (YₓGd₁₋ₓ)F₃:Tb, YF₃:Tb,Ce, GdF₃:Tb,Ce, and (YₓGd₁₋ₓ)F₃:Tb,Ce, where 0<x<1. As shown in the luminescent spectra of FIGS. 2, 3 and 4 for YF₃:Tb, GdF₃:Tb, and Y_{0.5}Gd_{0.5}F₃:Tb, respectively, when these materials are excited by vacuum ultraviolet light, the materials efficiently emit slightly greenish white-light of spectra with a peak wavelength at 543 nm among several other peaks in the green, blue and red bands. It is possible to provide white-light even with only one of the fluorescent materials. Since the combination of three red, green and blue light emitting fluorescent materials is unnecessary, the lamp cost can be lowered. In addition, the change in output light intensity and resulting color shift due to the aging of fluorescent materials can be prevented.

Further, in a second embodiment of the present invention, the fluoride-based fluorescent material is the material that is activated by rare-earth material and a composition of M(II)F₂:R (M(II) is at least one alkaline earth element selected from Ba, Mg, Ca and Sr, and R is a rare-earth-based activator including at least either Tb, or Tb and Ce). Such fluorescent materials include, for example, BaF₂:Tb, CaF₂:Tb, MgF₂:Tb, SrF₂:Tb, (BaₓCa₁₋ₓ)F₂:Tb, BaF₂:Tb,Ce, CaF₂:Tb,Ce, MgF₂:Tb,Ce, SrF₂:Tb,Ce, and (CaₓMg₁₋ₓ)F₂:Tb,Ce, where 0<x<1. These materials efficiently emit slightly greenish white-light of spectra with a peak wavelength at 543 nm among several other peaks in the green, blue and red bands, similarly to FIGS. 2 to 4. White-light can be provided even with only one of the fluorescent materials. Since the combination of three (red, green and blue light emitting) fluorescent materials is unnecessary, the lamp cost can be lowered. In addition, the change in output light intensity and resulting color shift due to aging of the fluorescent materials can be prevented.

Further, in a third embodiment of the present invention, the fluoride-based fluorescent material is the material that is activated by rare-earth material and a composition of M(I)F:R (M(I) is at least one alkaline metal selected from Li, Na, K, Rb and Cs, and R is a rare-earth-based activator including at least either Tb, or Tb and Ce). Such fluorescent materials are, for example, LiF:Tb, NaF:Tb, CsF:Tb, RbF:Tb, (LiₓNa₁₋ₓ)F:Tb, LiF:Tb,Ce, NaF:Tb,Ce, CsF:Tb,Ce, RbF:Tb,Ce, and (NaₓK₁₋ₓ)F:Tb,Ce, where 0<x<1. These materials efficiently emit slightly greenish white-light of spectra with a peak wavelength at 543 nm among several other peaks in the green, blue and red bands. White-light can be provided even with only one of the fluorescent materials. Since the combination of three (red, green and blue light emitting) fluorescent materials is unnecessary, the lamp cost can be lowered. In addition, the change in emitting light intensity and resulting color shift due to aging of the fluorescent materials can be prevented.

Further, in a fourth embodiment of the present invention, the visible light emitting fluorescent lamp using the aforementioned fluoride-based fluorescent materials will be described.

The lamp has a fluorescent layer using at least one of the fluorescent materials inside a transparent hermetic vessel. In addition, it features a discharge medium sealed in this vessel that efficiently emits vacuum ultraviolet light (ultraviolet light having a wavelength of 200 nm or shorter, such as 172 nm and 147 nm light emitted from Xe and 185 nm light emitted from Hg). One of the fluoride-based fluorescent materials or the mixture thereof may be used in the fluorescent layer of the lamp. As the discharge medium, xenon or mixtures of xenon and other rare gases are preferably used, and even mixtures of rare gases and Hg vapor can be used. The aforementioned fluoride-based fluorescent materials are excited by vacuum ultraviolet light radiated by discharge from Xe or Hg and then white-light is efficiently emitted that has a spectrum with a peak wavelength at 543 nm among other peaks on green, blue and red bands.

The fluorescent layer can be formed by applying a slurry of the fluorescent material powder, an organic binder and organic solvent onto the internal surface of the transparent vessel made of soda glass, for example. After the organic solvent has vaporized, the organic binder is decomposed and removed by baking. A water-soluble binder may also be used. When the surface of the transparent vessel tube is coated with the slurry, it is common practice to pour the slurry into the tube from an opening at one side. When the transparent vessel has a planar geometry or is hexahedral, the slurry is coated onto glass plates by a method such as spraying and screen printing, and then the glass plates may be assembled into a vessel. When the transparent vessel has a ball-like shape, the spray method and the dipping method are preferable.

The lamp can have various structures suitable for each application, depending on the geometry of the transparent hermetic vessel (straight, curve (U, ring, winding, spiral etc.), planar, sphere etc.), the type of electrode (hot cathode, cold cathode), electrode location (inner electrode, outer electrode), absence or presence of Hg and aperture, and other factors.

Then, a fluorescent lamp in a fifth embodiment of the present invention will be described. The lamp has color filters on the outer surface or in the vicinity of the transparent hermetic vessel, in order to raise the color purity of output light. When the filter is mounted with the reduced transmission of green light (peak wavelength at 543 nm), the color balance is improved and the whiteness is thereby raised. In contrast, when the filter is mounted with the reduced transmission of light of the other colors, the green purity can be raised. As a color filter, a transparent resin film, a sheet of a transparent glass substrate on which colorants such as dyes, pigments and oxides are printed are preferably used. Also preferred are color thin film fabricated by a thin film forming method such as vapor deposition, spattering and CVD, and a substrate in which dyes, pigments and oxides are dispersed. Such color filters are wound on or installed near the fluorescent lamp.

### EXAMPLES

### (Example 1)

A method of fabricating a rare-earth activated fluoride-based fluorescent material, YF₃:Tb, will be described.

First, 100 parts of YF₃ powder and one part of TbF₃ powder, by weight, were ground and mixed in a mortar. This mixture was then put in a halogen-resistant crucible and the crucible was placed in an electric furnace. The inside of the furnace was then raised to 1100° C. and the mixture was sintered at 1100° C. for three hours. The inside of the furnace was cooled down to room temperature and the sintered mixture was taken out. The mixture was ground in a mortar and screened to provide the YF₃:Tb fluorescent material. Since the ratio of TbF₃ powder to YF₃ powder was low, the Tb concentration in the resulting fluorescent material was low, and Tb acted as an activator.

A preferable sintering temperature is between 900 and 1200° C. The duration time at the sintering temperature should be 1-5 hours depending on the chosen sintering temperature and the amount of mixture provided for sintering. Preferred sintering atmospheres are air, inert atmospheres, for example nitrogen and rare gases, and weak-reducing atmospheres, for example nitrogen including a slight amount of hydrogen or carbon monoxide.

### (Example 2)

A GdF₃:Tb fluorescent material was obtained by the same method as that of Example 1 except that GdF₃ powder, instead of the YF₃ powder, was used.

### (Example 3)

50 parts of YF₃ powder, 50 parts of GdF₃ powder and one part of TbF₃ powder, all by weight, were ground and mixed in a mortar. This mixture was put in a halogen-resistant crucible and placed in an electric furnace. Next, the inside of the furnace was raised up to 1100° C. and the mixture was sintered at this temperature for three hours. The inside of the furnace was cooled down to room temperature and the sintered mixture was taken out. The sintered mixture was ground in a mortar and screened to provide the (Y_{0.5}Gd_{0.5})F₃:Tb fluorescent material.

### (Example 4)

100 parts of YF₃ powder, one part of TbF₃ powder and one part of CeF₃ powder, all by weight, were ground and mixed in a mortar. This mixture was put in a halogen-resistant crucible and placed in an electric furnace. Next, the inside of the furnace was raised up to 1100° C. and the mixture was sintered at this temperature for three hours. The inside of the furnace was cooled down to room temperature and the sintered mixture was taken out. The sintered mixture was ground in a mortar and screened to provide the YF₃:Tb,Ce fluorescent material.

### (Example 5)

The GdF₃:Tb,Ce fluorescent material was obtained by the same method as that of Example 4 except that GdF₃ powder, instead of the YF₃ powder, was used.

### (Example 6)

50 parts of YF₃ powder, 50 parts of GdF₃ powder, one part of TbF₃ powder and one part of CeF₃ powder, all by weight, were ground and mixed in a mortar. This mixture was put in a halogen-resistant crucible and placed in an electric furnace. Next, the inside of the furnace was raised up to 1100° C. and the mixture was sintered at this temperature for three hours. The inside of the furnace was cooled down to room temperature and the sintered mixture was taken out. The mixture was grounded in a mortar and screened to provide the (Y_{0.5}Gd_{0.5})F₃:Tb,Ce fluorescent material.

### (Example 7)

The BaF₂:Tb,Ce fluorescent material was obtained by the same method as that of Example 4 except that BaF₂ powder, instead of the YF₃ powder, was used.

### (Example 8)

The CaF₂:Tb,Ce fluorescent material was obtained by the same method as that of Example 4 except that CaF₂ powder, instead of the YF₃ powder, was used.

### (Example 9)

The (Ba_{0.5}Ca_{0.5})F₂:Tb,Ce fluorescent material was obtained by the same method as that of Example 6 except that BaF₂ powder, instead of the YF₃ powder, and CaF₂ powder, instead of the GdF₃ powder, were used.

### (Example 10)

The LiF:Tb,Ce fluorescent material was obtained by the same method as that of Example 4 except that LiF powder, instead of the YF₃ powder, was used.

### (Example 11)

The NaF:Tb,Ce fluorescent material was obtained by the same method as Example 4 except that NaF powder, instead of the YF₃ powder, was used.

### (Example 12)

The (Li_{0.5}Na_{0.5})F:Tb,Ce fluorescent material was obtained by the same method as that of Example 6 except that LiF powder, instead of the YF₃ powder, and NaF powder, instead of the GdF₃ powder, were used.

### (Comparative Example)

The conventional LaPO₄:Tb,Ce fluorescent material is taken as a comparative example.

(Method of Evaluating Fluorescent Material and Evaluation Result)

A 10 μm thick fluorescent layer was formed on a glass substrate, using each of the fluorescent materials described in Examples 1 to 12 and the comparative example. This glass plate was placed in a nitrogen atmosphere, and the fluorescent layer was irradiated by vacuum ultraviolet light with a constant intensity which had a peak wavelength at about 170 nm and was emitted from a vacuum ultraviolet source (excimer lamp or xenon lamp). Then, the luminescent spectrum and luminescent intensity were measured. Examples of the measured luminescent spectra are illustrated in FIGS. 2 to 4. FIG. 5 shows the luminescent spectrum of the conventional LaPO₄:Tb,Ce fluorescent material. The luminescent intensities of each of the fluorescent materials in Examples and the comparative example are shown in Table 1 with relative magnitude (the luminescent intensity of the comparative example is 100). Compared with the comparative example, the fluoride-based fluorescent materials of Examples show higher intensities of light in the blue band and thus provide white light of better color balance.

Next, examples of fluorescent lamps using the fluoride-based fluorescent materials of Examples will be described. Although a rare gas of which the major part is xenon is used as the discharge medium in the following examples, a mixture gas of rare gases such as argon and Hg vapor may also be used as is the case with conventional fluorescent lamps. The cold cathode used as the inner electrode in the following examples may be replaced by a hot cathode. The geometry of the transparent hermetic vessel is not limited to that shown in the examples.

TABLE 1

| | | Relative |
|---|---|---|
| | Composition of | luminescent |
| Example | fluorescent material | intensity |
| Example 1 | YF₃:Tb | 120 |
| Example 2 | GdF₃:Tb | 105 |
| Example 3 | (Y_{0.5}Gd_{0.5})F₃:Tb | 110 |
| Example 4 | YF₃:Tb,Ce | 130 |
| Example 5 | GdF₃:Tb,Ce | 107 |
| Example 6 | (Y_{0.5}Gd_{0.5})F₃:Tb,Ce | 120 |
| Example 7 | BaF₂:Tb,Ce | 120 |
| Example 8 | CaF₂:Tb,Ce | 118 |
| Example 9 | (Ba_{0.5}Ca_{0.5})F₂:Tb,Ce | 117 |
| Example 10 | LiF:Tb,Ce | 105 |
| Example 11 | NaF:Tb,Ce | 104 |
| Example 12 | (Li_{0.5}Na_{0.5})F:Tb,Ce | 103 |
| Comparative | LaPO₄:Tb,Ce | 100 |
| example | | |

### (Example 13)

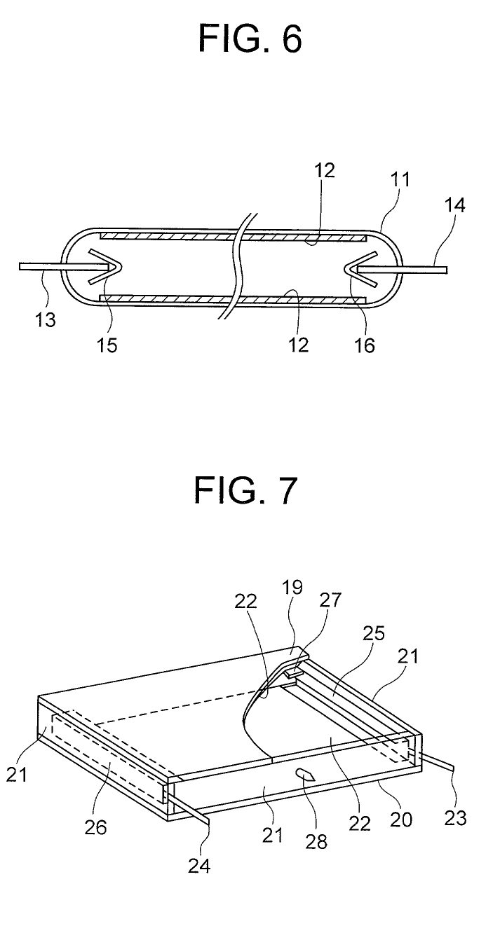

This example relates to a straight tube type cold cathode fluorescent lamp. This fluorescent lamp includes a structure of which the primary part is shown in the cross-sectional view of FIG. 6. On the internal surface of a soda glass tube 11 (outer diameter of 4.0 mm, inner diameter of 3.0 mm, and length of about 300 mm) which is a transparent hermetic vessel, a fluorescent layer 12 is formed that is made of a terbium, cerium-activated yttrium-fluoride fluorescent material (YF₃:Tb,Ce described in Example 4) of about 20 μm thick that emits light when excited by vacuum ultraviolet light. Rare gases of which the major element is xenon are sealed in the glass tube 11 under a predetermined pressure. The fluorescent layer 12 is formed by pouring a solution of 100 parts by weight of YF₃:Tb,Ce fluorescent material, 30 parts by weight of an organic binder including polyvinyl alcohol, and pure water into one of the open ends of the glass tube 11. Leads 13 and 14 are sealed in both ends of the glass tube 11. Cold cathodes 15 and 16 each made of a folded Ni—Fe metallic plate are fixed by welding at the front ends the leads 3 and 4. Zr—Al alloy (not shown) is formed as a getter on a side of each of the cold cathodes 5 and 6. The glass tube 11 is heated and evacuated, then the cold cathodes 15 and 16 are heated by high frequency induction to be degassed, and then xenon or xenon-based rare gas is sealed in the glass tube. The exhaust tube (not shown) is then sealed to make the glass tube air-tight. Residual impure gases in the glass tube are adsorbed by the getter.

When a high frequency voltage (for example, several tens kHz) is applied to the cold cathodes 15 and 16 for inducing discharge, thereby emitting vacuum ultraviolet light from xenon, the excited fluorescent layer 12 efficiently emits white-light having a peak wavelength at around 543 nm, as shown in FIG. 2.

### (Example 14)

This example relates to a flat type fluorescent lamp. The lamp includes a structure shown in the perspective view of FIG. 7. A pair of soda glass plates 19 and 20 and four side glass plates 21 are assembled into a transparent hexahedral hermetic vessel using glass solder (for example, outer dimensions are 100 mm×50 mm×9 mm, glass thickness is 2 mm). At least one of the glass plates 19 and 20 has on its inside a YF₃:Tb,Ce fluorescent layer 22 having a thickness of about 20 μm, and a xenon-based rare gas is sealed in the vessel. The fluorescent layer 22 is formed by screen printing ink containing the YF₃:Tb,Ce fluorescent material, organic binder and organic solvent onto the glass plates 19 and 20 before their assembly. Inside the pair of side glass plates 21 facing to each other, hollow cold cathodes 25 and 26, which are metallic (for example, Ni) plates of a rectangular U shape are mounted. Leads 23 and 24 extend from the ends of the cold cathodes 25 and 26. On the other side of the cold cathode 25, a getter 27 made of Zr—Al alloy is fixed by welding.

Such a vessel is put in a vacuum apparatus and degassed by heating. Next, the cold cathodes 25 and 26 and the getter 27 are heated by high frequency induction to be degassed; and the exhaust tube 28 is sealed after a rare gas is sealed in the vessel. When a high frequency (several tens kHz) voltage is applied to the cold cathodes 25 and 26 for inducing discharge, in order to make xenon emit vacuum ultraviolet light, the fluorescent layer emits white-light at a high efficiency. As a modified example, instead of the fluorescent powder, thin films of YF₃:Tb,Ce, for example, made by a method such as spattering, vapor deposition and CVD can be used in the fluorescent layer 22. The electrode geometry is not limited to that described in the example.

### (Example 15)

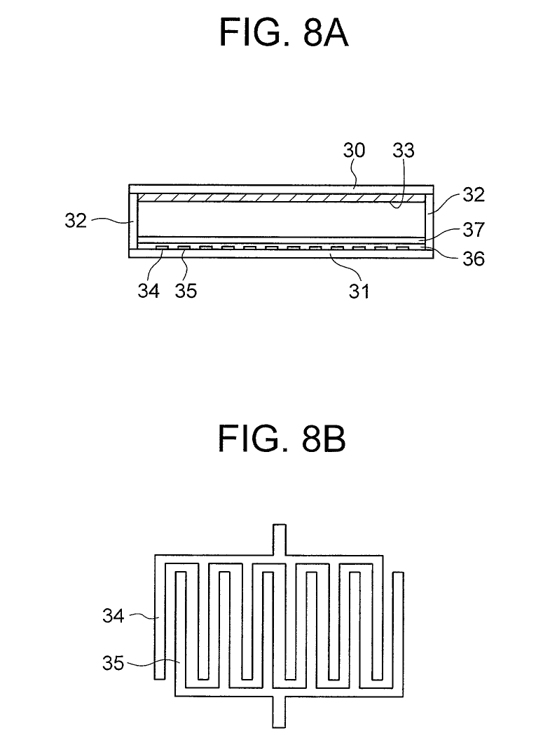

This example is another embodiment of the flat type fluorescent lamp including a thin hexahedral structure shown in FIG. 8A. A pair of soda glass plates 30 and 31 and side glass plates 32 are assembled into a hexahedral hermetic vessel which is air-tight by glass solder (outer dimensions are 100 mm×50 mm×6 mm, glass thickness is 2 mm). The front glass plate 30 has a fluorescent layer 33 which is about 20 μm thick and contains the YF₃:Tb,Ce fluorescent material on its inner surface, and xenon is sealed in this hermetic vessel. The fluorescent layer 33 is formed by the screen printing of ink containing the fluorescent material, organic binder and organic solvent. On the other hand, a plurality of ITO (Indium Tin Oxide) electrodes 34 and 35, which are formed by a method such as like vapor deposition and spattering, are arrayed on the inner surface of the back glass plate 31, and the electrodes are covered with a dielectric layer 36 made of SiO₂, for example. A protective layer 37 made of MgO, for example, is formed thereon. The electrodes are formed, as shown in FIG. 8B, such that the pair of the comb-like electrodes 34 and 35 are arrayed alternatively. This electrode geometry can be provided by etching a pattern of ITO films, or can also be formed by vapor deposition and spattering using a mask.

The protective layer 37 protects the dielectric layer 36 from the spattering during discharge and lowers the discharge initiation voltage by raising the secondary electron emission coefficient. The electrodes 34 and 35 may be exposed to the discharge space without using the dielectric layer 36 and the protection layer 37. When a high frequency voltage is applied to the electrodes 34 and 35 for inducing discharge, and vacuum ultraviolet light from xenon irradiates the fluorescent layer 33, white-light is emitted at high efficiency. When a similar fluorescent layer is also formed on the back glass plate 31, the luminescent intensity can be raised. A metal such as aluminum may be used instead of ITO as electrode materials. As a modified example, instead of the fluorescent powder, a thin film of YF₃:Tb,Ce, for example, made by a method such as spattering, vapor deposition and CVD may be used in the fluorescent layer 33.

### (Example 16)

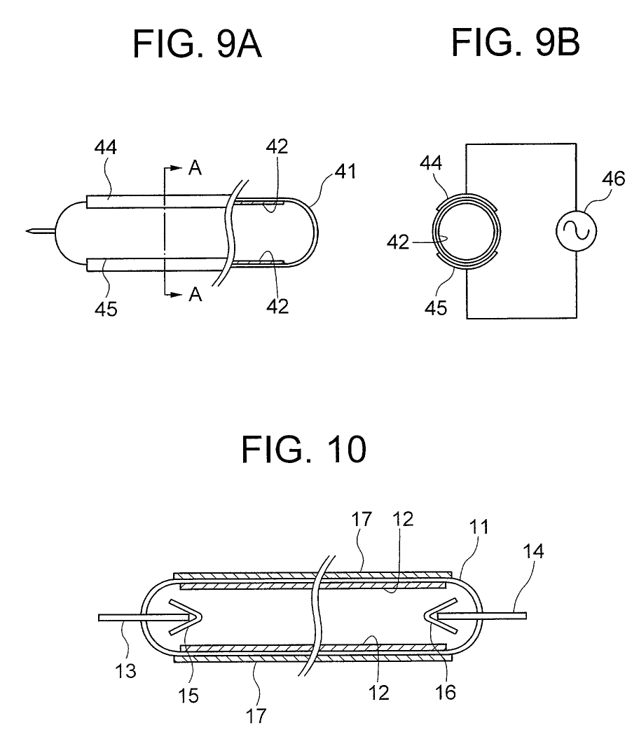

This example relates to a fluorescent lamp having no internal electrode in the transparent hermetic vessel. In the fluorescent lamp, a high frequency electromagnetic field is applied to the inside of the transparent hermetic vessel via external electrodes. Then the discharge medium sealed in the vessel is excited and the fluorescent material emits light. The fluorescent lamp has a structure as shown in FIGS. 9A and 8B. This lamp has external electrodes 44 and 45 made of a pair of band conductors formed along the tube axis on the external surface of the transparent hermetic vessel made of a soda glass tube 41. A fluorescent layer 42 made of YF₃:Tb,Ce fluorescent material having a thickness of about 20 μm is formed on the inner surface of the transparent hermetic vessel. Xenon-based rare gases are sealed in this transparent hermetic vessel. Various methods of forming the fluorescent layer 42 may be used. For example, the layer 42 can be formed on the inner surface of the tube by pouring a mixed solution of the fluorescent material, organic binder and organic solvent into the glass tube and then removing the excessive mixture. When a high frequency voltage generated by a high frequency power source 46 is applied to the external electrodes 44 and 45 of the fluorescent lamp having no inner electrodes to induce discharge and vacuum ultraviolet light emits from xenon, the fluorescent material 42 emits white-light at high efficiency. Such a fluorescent lamp having no inner electrodes or leads has a long life and a simple structure and is inexpensive. The geometry of the transparent hermetic vessel is not limited to a straight tube but may take various shapes such as U-ring, winding and spiral-curvature, planar and ball shapes. The external electrodes may also take the form of a coil, net and facing plate, not limited to the above form in the embodiment. Any conductive material such as metal, carbon, ITO and conductive resin may be used for the material of the electrodes.

### (Example 17)

This example is a fluorescent lamp that disposes a color filter on the outer surface of the transparent hermetic vessel in order to control the luminescent spectrum and improve the whiteness of output light. FIG. 10 shows the major part of the lamp that has a resin-film type color filter 17 on the outer surface of the soda glass tube 11 of the straight tube type cold cathode fluorescent lamp shown in FIG. 6. Since the fluoride-based fluorescent lamp emits slightly greenish white-light, the use of a color filter is recommended for attenuating green light for higher whiteness. Specifically, a color filter is preferred that can make the transmission of the 543 nm wavelength green light about 10% lower than that of light of the other wavelengths. As a modified example, a green-light emitting fluorescent lamp can be provided by employing a filter that reduces the transmission of light other than the 543 nm green light to improve the purity of the green color. The color filter can be made by, for example, the following: printing a filter layer of colorants such as dye, pigment and oxide on a transparent substrate such as a transparent resin film and transparent glass plate; forming a filter film on a transparent substrate by a thin film fabricating method such as vapor deposition, spattering and CVD; dispersing colorants such as dye, pigment and oxide in a transparent substrate; dispersing colorants in resin. Different types of color filters may be used according to the geometry of each fluorescent lamp. If the lamp is a tube, a flexible resin film is preferable as the color filter and it can be wound on the fluorescent lamp. If the filter is made of glass it is suitable for use in flat hexahedral fluorescent lamps. Of course, the color filter can be disposed close to the lamp but not in contact with the lamp. If a liquid resin in which colorants are dispersed is coated on the lamp, the fluorescent lamp may take any form of geometry.

Since the above embodiments are described only for examples, the present invention is not limited to the above embodiments and various modifications or alterations can be easily made therefrom by those skilled in the art without departing from the scope of the present invention.

What is claimed is:

1. A fluoride-based fluorescent material designated by a composition formula of MFₙ:R, wherein M is at least one element selected from the group consisting of rare earth elements, Al and Bi, alkaline earth metals, and alkaline metals, R is a rare-earth-based activator including at least either Tb or Tb and Ce, and n=1, 2 or 3.

2. The fluoride-based fluorescent material as defined in claim 1, wherein the composition formula is M(III)F₃:R, wherein M(III) is at least one element selected from the group consisting of rare-earth elements, Al and Bi, and R is the rare-earth-based activator including at least either Tb or Tb and Ce.

3. The fluoride-based fluorescent material as defined in claim 1, wherein the composition formula is M(II)F₂:R, wherein M(II) is at least one alkaline earth metal selected from the group consisting of Ba, Mg, Ca and Sr, and R is the rare-earth-based activator including at least either Tb or Tb and Ce.

4. The fluoride-based fluorescent material as defined in claim 1, wherein the composition formula is M(I)F:R, wherein M(I) is at least one alkaline metal selected from the group consisting of Li, Na, K, Rb and Cs, and R is the rare-earth-based activator including at least either Tb or Tb and Ce.

5. A fluorescent lamp comprising a transparent hermetic vessel, a fluorescent layer including the fluorescent material as defined in claim 1 inside the transparent hermetic vessel, a discharge medium sealed in the hermetic vessel, and a pair of electrodes for discharging the discharge medium.

6. The fluorescent lamp as defined in claim 5, wherein the discharge medium contains at least Xe, and radiates vacuum ultraviolet light.

7. The fluorescent lamp as defined in claim 5, wherein the pair of the electrodes includes a cold cathode or a hot cathode.

8. The fluorescent lamp as defined in claim 5, wherein the transparent vessel is flat.

9. The fluorescent lamp as defined in claim 5, wherein the pair of the electrodes are disposed outside the transparent hermetic vessel.

10. The fluorescent lamp as defined in claim 5 further comprising a color filter disposed in association with the fluorescent layer.
